(19) United States
(12) Patent Application Publication
(10) Pub. No.: US 2009/0229750 A1
(43) Pub. Date: Sep. 17, 2009

(54) Method for producing copper-clad laminate

(75) Inventors: Toyonari ITO, Tsukuba-shi (JP); Satoshi OKAMOTO, Tsukuba-shi (JP); Junichi IKEUCHI, Tsukuba-shi (JP)

Correspondence Address: FOLEY AND LARDNER LLP;SUITE 500, 3000 K STREET NW, WASHINGTON, DC, 20007, US

(73) Assignee: SUMITOMO CHEMICAL COMPANY. LIMITED

(21) Appl. No.: 12/382,070

(22) Filed: Mar. 6, 2009

(30) Foreign Application Priority Data
Mar. 11, 2008 (JP) 2008-060807

(51) Int. Cl. B32B 37/06; B32B 37/00

(52) U.S. Cl. 156/322; 156/60

(57) ABSTRACT

The present invention provides a method for producing a copper-clad laminate, the method comprising the step of placing at least one copper foil onto a resin layer containing a liquid crystalline polymer so that the resin layer adheres to a surface of the copper foil, wherein the surface of the copper foil has 0.4 or more of a ratio of nickel concentration to copper concentration and has substantially no silicon detected when measured with X-ray photoelectron spectroscopy. The copper-clad laminate can sufficiently maintain excellent adhesion between the copper foil and the resin layer even under high temperature and humidity atmosphere.

### BACKGROUND OF THE INVENTION

1. Field of the Invention

The present invention relates to a method for producing a copper-clad laminate which can be utilized, for example, as a printed-circuit board, and more specifically to a method for producing a copper-clad laminate comprising a resin layer containing a liquid crystalline polymer.

2. Description of the Related Art

A copper-clad laminate having a resin layer on copper foil is known as a substrate for a flexible printed-circuit board. Such a copper-clad laminate is used as a flexible printed-circuit board (occasionally referred to as “FPC” hereinafter) in such a manner that a copper foil is processed with etching to form a circuit pattern.

In recent years, various studies of FPC provided as an insulating layer with a resin layer containing a liquid crystalline polymer have been in progress for the reason that the resin layer is excellent in electrical characteristics such as dielectric characteristics, but yet it has been generally pointed out that the resin layer containing a liquid crystalline polymer is low in adhesion properties to the copper foil. Conventionally, a method for producing a copper-clad laminate, wherein a liquid crystalline polymer film previously formed is joined to a copper foil, has been mainly studied. For example, Japanese Unexamined Patent Publication No. 2006-130761 discloses a method for producing a copper-clad laminate in which a liquid crystalline polymer film and a copper foil are subject to thermo-compression bonding under the temperature conditions of 150 to 300° C. Also, Japanese Unexamined Patent Publication No. 2007-129208 discloses a method for producing a copper-clad laminate in which a solution comprising a liquid crystal polyester and a solvent is applied onto an extra-thin copper foil with a thickness of 5 μm or less and then the solvent is removed from the applied film on the copper foil.

### SUMMARY OF THE INVENTION

As described above, various studies have been performed to improve the copper-clad laminate in adhesion properties between the copper foil and the resin layer. However, the copper-clad laminate having excellent adhesion properties even when maintained under the conditions of high temperature and high humidity has not been obtained. In producing a FPC using such a copper-clad laminate, an electrical and electronic equipment provided with the FPC tends to easily cause malfunction due to long-term use, which may lower reliability in the electrical and electronic equipment.

Under such circumstances, one of objects of the present invention is to provide a method for producing a copper-clad laminate which can sufficiently maintain excellent adhesion properties between the copper foil and the resin layer even under such high temperature and humidity atmosphere. Another one of objects of the present invention is to produce such an excellent copper-clad laminate and a double-sided copper-clad laminate using such a copper-clad laminate.

The inventors of the present invention have accomplished the present invention through earnest studies to achieve the objects.

Thus the present invention provides a method for producing a copper-clad laminate, the method comprising the step of placing at least one copper foil onto a resin layer containing a liquid crystalline polymer so that the resin layer adheres to a surface of the copper foil, wherein the surface of the copper foil has 0.4 or more of a ratio of nickel concentration to copper concentration and has substantially no silicon detected when measured with X-ray photoelectron spectroscopy.

Further, the present invention provides a one-sided copper-clad laminate and a double-sided copper-clad laminate, both of which are excellent in adhesion properties between the copper foil(s) and the resin layer, and are obtainable by the above-mentioned method.

Moreover, the present invention provides a method for improving adhesion properties between a copper foil(s) and a resin layer in a copper-clad laminate.

In accordance with the present invention, such a copper-clad laminate is provided that adhesion properties between a copper foil and a resin layer containing a liquid crystalline polymer are excellent, the adhesion properties being sufficiently maintained even though retained under high temperature and humidity atmosphere. The copper-clad laminate obtained in the present invention, which may be one-sided or a double-sided copper-clad laminate, is extremely useful in industry because the laminate can provide a FPC high in practicability and resistant to long-term use.

### PREFERRED EMBODIMENTS OF THE INVENTION

Hereinafter, a copper foil to be used in the present invention, a liquid crystalline polymer preferably used in the present invention, a resin layer containing the liquid crystalline polymer, a copper-clad laminate obtained in the present invention are sequentially described, while describing a preferred embodiments of a method for producing a copper-clad laminate of the present invention.

In the present invention, a copper-clad laminate in produced by a method which comprises the step of placing at least one copper foil onto a resin layer containing a liquid crystalline polymer so that the resin layer adheres to a surface of the copper foil, wherein the surface of the copper foil has 0.4 or more of a ratio of nickel concentration to copper concentration and has substantially no silicon detected when measured with X-ray photoelectron spectroscopy.

### <Copper Foil>

First, a copper foil to be used or preferably used in the present invention is described.

The copper foil has a surface with a ratio of nickel concentration to copper concentration is in the range of from 0.4 or more and with substantially no silicon concentration detected when measured with X-ray photoelectron spectroscopy (XPS). Typically, the XPS measurement can be conducted under the conditions as follows:

While irradiating X-rays onto a surface to be measured, a photoelectron is measured under the conditions that a photoelectron take-off angle is 35° from the surface, and nickel concentration C_{Ni} (% by atom) is calculated from peak area of Ni2p_{3/2} including a satellite peak, and copper concentration C_{Cu} (% by atom) is calculated frompeak area of Cu2p_{3/2}. In addition, silicon concentration C_{Si} (% by atom), or particularly the presence/absence of silicon, is detected from peak of Si2p.

In the present invention, SSX-100 (X-rays: AlKα ray (1486.6 eV), X-ray spot diameter: 1000 μm) manufactured by SSI (Surface Science Instruments) is used as an analysis device for the XPS measurement.

The copper foil in the present invention is has a surface such that the ratio (C_{Ni}/C_{Cu}) of nickel concentration to copper concentration thus calculated is in the range of from 0.4 or more, and preferably in the range of from 0.42 or more. When the ratio C_{Ni}/C_{Cu} of the surface of the copper foil is less than 0.4, the resulting copper-clad laminate tends to easily decrease in adhesion properties between the copper foil and the resin layer under high temperature and humidity atmosphere.

As mentioned above, the copper foil in the present invention has a surface with substantially no silicon concentration detected when the XPS measurement is performed under the above-described conditions. Herein, no substantial detection means that the ratio of silicon concentration to copper concentration is less than 0.01. When the copper foil having a surface with silicon detected is used, the resulting copper-clad laminate also tends to easily decrease in adhesion properties between the copper foil and the resin layer under high temperature and humidity atmosphere.

Such tendency which may relate to the physical properties of the surface of the copper foil in the copper-clad laminate is found out for the first time by the study of the inventors of the present invention.

One of examples of the preferable copper foil, which meets the properties such that C_{Ni}/C_{Cu} is 0.40 or more and silicon is not substantially detected, can be selected from electrolytic copper foils.

For example, an electrolytic copper foil as preferable copper foil used in the present invention may be obtained as follows:

Copper is precipitated on a cathode by copper electrolysis to form a copper foil and the copper foil surface facing the cathode side on the occasion of peeling the copper foil off the cathode is subjected to surface treatment. Typically, a copper foil produced by electrolysis is produced in such a manner that a cathode is immersed in a copper sulfate electrolytic solution, in a continuous production method, a drum-shaped rotational cathode is immersed in the copper sulfate electrolytic solution to precipitate copper on the cathode surface by electrolytic reaction and then form copper foil, which is peeled off the cathode surface. In such an electrolytic copper foil, a plane on the side with electrodeposition started on the cathode surface, that is, in the initial electrodeposition is called a shiny surface, and an opposite plane on the side with electrolysis finished is called a roughened surface, both of which are distinguished. Then, the shiny surface is a smooth surface as the transferred shape of the cathode surface, and the roughened surface is a surface with irregularities. The copper foil to be used in the present invention may be easily formed by determining a specific component for the copper foil roughened surface.

Next, a metal layer containing nickel (a nickel layer) is formed on the surface of the copper foil. Examples of a forming method for the nickel layer include an electroless plating, electroplating, substitution reaction, spray atomizing, application, spattering and evaporation method. Examples of the formation of the nickel layer as an easy method include a method for electroplating by a nickel sulfate aqueous solution. The concentration and temperature of the nickel sulfate aqueous solution used for electroplating or the time for immersing the copper foil in nickel sulfate aqueous solution are properly adjusted for obtaining a copper foil having a predetermined nickel concentration on the surface. Preferably, preliminary experiments are performed several times, and the surfaces of the copper foil obtained by the preliminary experiments are each subject to XPS measurement to calculate nickel concentration and copper concentration, and then the electroplating conditions such that C_{Ni}/C_{Cu} is in the above-mentioned range may be selected. Then, the above-mentioned nickel sulfate aqueous solution used for electroplating is such that silicon component is not contained.

Alternatively, a copper foil to be used in the present invention may be selected from among commercially available copper foils. Please note that, most of commercially available copper foils are subjected to the silane coupling agent treatment, and silicon is detected in performing XPS measurement on the above-mentioned measurement conditions. Accordingly, it is preferably to select a copper foil for the present invention from among copper foils not subjected to the silane coupling agent treatment when selecting from commercially available copper foils.

The copper foil in the present invention may have been subjected to physical treatment such as roughening treatment and chemical surface treatment (including acid washing) for the purpose of securing adhesive force to a resin layer containing a liquid crystalline polymer as long as it does not adversely affect the present invention.

Preferable thickness of copper foil is in the range of from 5 to 150 μm, more preferably in the range of from 10 to 70 μm, and most preferably in the range of from 10 to 35 μm. The thinning of the thickness of the copper foil is preferable in view of being capable of forming a fine pattern, but yet too much thinning of the thickness thereof may cause wrinkles on copper foil in the production process, and additionally may cause rupture of wiring and decreasing reliability of a circuit board on the occasion of forming a circuit on the copper foil. On the other hand, the thickening of the thickness of the copper foil may cause taper on the side face of a circuit and may be difficult in forming a fine pattern on the occasion of forming a circuit on copper foil by etching.

The ratio of the thickness of a resin layer (described below) used in the present invention to the thickness of the copper foil is preferably within a range from 0.7 to 20. Considering the ratio, the appropriate thickness of the copper foil may be determined in accordance with the thickness of the resin layer.

Preferably, the copper foil used in the present invention has a surface such that no peak of 852 eV derived from Ni2p_{3/2} among peaks for detecting nickel (which can be calculated by performing XPS measurement on the above-mentioned measurement conditions) is substantially detected. In this case, in a spectrum obtained by XPS measurement, the observed spot of the main peak of C1s is calibrated as 284.6 eV. Then, in a case of analyzing the waveform of the obtained Ni2p_{3/2} spectrum, a peak of 852 eV derived from Ni2p_{3/2} is regarded as not substantially detected when peak area of 852 eV is less than 1% with respect to the Ni2p_{3/2} spectrum.

### <Liquid Crystalline Polymer>

In the present invention, a resin layer comprising a liquid crystalline polymer is placed on the above-described copper foil, to produce a copper-clad laminate. Next, a liquid crystalline polymer for the resin layer is described below.

The liquid crystalline polymer may be a thermotropic liquid crystalline polymer and can form a melt exhibiting optical anisotropy at temperature of 450° C. or lower. Preferable examples of the liquid crystalline polymer include liquid crystal polyester having an aromatic group which is linked by an ester bond. The preferable example liquid crystal polyester include a liquid crystal polyester-amide in which a part of the ester bonds in the polymer are replaced with an amide bond.

The above-mentioned liquid crystalline polymer preferably contains structural units represented by the following formulae (1), (2) and (3), and it is preferable that a structural unit represented by the formula (1) is 30 to 80% by mol, a structural unit represented by the formula (2) is 10 to 35% by mol, and a structural unit represented by the formula (3) is 10 to 35% by mol, with respect to the total of the structural units (1), (2) and (3).

—O—Ar¹—CO— (1)

—CO—Ar²—CO— (2)

—X—Ar³—Y—. (3)

Here, Ar¹ denotes phenylene, naphthylene or biphenylene; Ar² denotes phenylene, naphthylene, biphenylene or a divalent group represented by the formula (4); and Ar³ denotes phenylene or a divalent group represented by the formula (4). X and Y each independently denote O (an oxygen atom) or NH (an amino group). A hydrogen atom bonding to the aromatic ring in Ar¹, Ar² and Ar³ may be substituted with a halogen atom, an alkyl group or an aryl group.

The divalent group represented by the formula (4) is as follows.

—Ar¹⁰-Z-Ar¹¹—. (4)

Here, Ar¹⁰ and Ar¹¹ each independently denote phenylene or naphthylene; and Z denotes O (an oxygen atom), CO (a carbonyl group) or SO₂ (a sulfonyl group).

The liquid crystalline polymer containing these structural units has the advantage of being excellent in dimensional stability, and may be preferably used for a resin layer in a copper-clad laminate of the present invention. This advantage is disclosed in the above-mentioned Japanese Unexamined Patent Publication No. 2007-129208.

The structural unit (1) may be a structural unit derived from aromatic hydroxycarboxylic acid, the structural unit (2) may be a structural unit derived from aromatic dicarboxylic acid, and the structural unit (3) may be a structural unit derived from aromatic diol, aromatic diamine or aromatic amine having a hydroxyl group. Alternatively, these structural units (1) to (3) may be ester-forming derivatives corresponding thereto, the ester-forming derivatives including derivatives which can provide amide bonds.

Examples of the ester-forming derivative of carboxylic acid include those in which a carboxyl group is a derivative high in reaction activity, such as acid chloride and acid anhydride, so as to promote reaction for producing polyester and polyamide, and those in which a carboxyl group forms ester with alcohols and ethylene glycol so as to produce polyester by transesterification.

Examples of the ester-forming derivative of a phenolic hydroxyl group include those in which a phenolic hydroxyl group forms ester with carboxylic acids so as to produce polyester by transesterification.

Examples of the ester-forming derivative of an amino group include those in which an amino group forms amide with carboxylic acids so as to produce polyester or polyamide by transesterification.

More specifically, examples of the structural units in the liquid crystalline polymer used for the present invention include the followings:

Examples of the structural unit (1) include structural units derived from para-hydroxybenzoic acid, 2-hydroxy-6-naphthoic acid and 4-hydroxy-4′-biphenylcarboxylic acid; two kinds or more of the above-mentioned structural units may be contained in all structural units. Among these structural units, a structural unit derived from 2-hydroxy-6-naphthoic acid is preferably contained.

The structural unit (1) is preferably contained in the liquid crystalline polymer used for the present invention in the amount of from 30 to 80% by mol, more preferably 32 to 70% by mol, and far more preferably 35 to 50% by mol, with respect to the total of all the structural units. When the ratio of the structural unit (1) with respect to the total of all the structural units is in this range, the liquid crystalline polymer develops sufficient liquid crystallinity and has sufficient solubility in solvent, so as to bring the advantage that the formation of a resin layer by the after-mentioned cast method is facilitated.

Examples of the structural unit (2) include structural units derived from terephthalic acid, isophthalic acid, 2,6-naphthalene dicarboxylic acid and 4,4′-oxydiphenyl dicarboxylic acid; two kinds or more of the above-mentioned structural units may be contained in all structural units. Among these structural units, the liquid crystalline polymer containing a structural unit derived from isophthalic acid is preferable in view of favorable solubility in solvent.

The structural unit (2) is preferably contained in the liquid crystalline polymer used for the present invention in the amount of from 35 to 10% by mol, more preferably 34 to 15% by mol, and far more preferably 32.5 to 25% by mol with respect to the total of all structural units. When the ratio of the structural unit (2) with respect to the total of all structural units is in this range, the liquid crystalline polymer develops sufficient liquid crystallinity and has sufficient solubility in solvent, so as to bring the advantage that the formation of a resin layer by the after-mentioned cast method is facilitated.

Examples of the structural unit (3) include structural units derived from hydroquinone, resorcin, 4,4′-dihydroxybiphenyl, 3-aminophenol, 4-aminophenol, 1,4-phenylenediamine, 1,3-phenylenediamine and 4,4′-dihydroxydiphenyl; two kinds or more of the above-mentioned structural units may be contained in all structural units. Among these structural units, from the viewpoint of easily forming a liquid crystalline polymer solution containing the liquid crystalline polymer and solvent, and allowing excellent adhesion properties between a resin layer and copper foil, the liquid crystalline polymer containing a structural unit in which at least one of X and Y of the structural unit (3) is —NH— is preferable, and the liquid crystalline polymer containing a structural unit derived from 4-aminophenol is preferably used.

The structural unit (3) is preferably contained in the liquid crystalline polymer used for the present invention in the amount of from 35 to 10% by mol, more preferably 34 to 15% by mol, and far more preferably 32.5 to 25% by mol with respect to the total of all structural units. When the ratio of the structural unit (3) with respect to the total of all structural units is in this range, the liquid crystalline polymer develops sufficient liquid crystallinity and has sufficient solubility in solvent, so as to bring the advantage that the formation of a resin layer by the after-mentioned cast method is facilitated.

The structural unit (3) is preferably substantially equivalent to the structural unit (2), and yet the polymerization degree of the liquid crystalline polymer may be also controlled so that the structural unit (3) becomes 90% by mol to 110% by mol with respect to the structural unit (2).

A method for producing the liquid crystalline polymer used in the present invention is not particularly limited. Examples of the method include a method in which a phenolic hydroxyl group and an amino group of aromatic hydroxy acid corresponding to the structural unit (1), and aromatic diol, aromatic amine having a hydroxyl group and/or aromatic diamine corresponding to the structural unit (3) are acylated by an excessive amount of fatty acid anhydride to obtain an acylated product, and then the obtained acylated product and aromatic dicarboxylic acid corresponding to the structural unit (2) are transesterified (polycondensed) and melt-polymerized (see, Japanese Unexamined Patent Publication No. 2002-220444 and Japanese Unexamined Patent Publication No. 2002-146003).

In the acylation reaction, the added amount of fatty acid anhydride is preferably by 1 to 1.2 times, more preferably by 1.05 to 1.1 times equivalent to the total of a phenolic hydroxyl group and an amino group. An added amount of fatty acid anhydride less than 1.0-time equivalence causes the acylated product and a raw monomer to sublime during transesterification (polycondensation) and brings a tendency to easily block the reaction system, while an added amount more than 1.2-times equivalence brings a tendency to remarkably color the obtained liquid crystalline polymer.

The acylation reaction is performed preferably at a temperature of 130 to 180° C. for 5 minutes to 10 hours, more preferably at a temperature of 140 to 160° C. for 10 minutes to 3 hours.

Fatty acid anhydride used for the acylation reaction is not particularly limited; examples thereof include acetic anhydride, propionic anhydride, butyric anhydride, isobutyric anhydride, valeric anhydride, pivalic anhydride, 2-ethylhexoic anhydride, monochloroacetic anhydride, dichloroacetic anhydride, trichloroacetic anhydride, monobromoacetic anhydride, dibromoacetic anhydride, tribromoacetic anhydride, monofluoroacetic anhydride, difluoroacetic anhydride, trifluoroacetic anhydride, glutaric anhydride, maleic anhydride, succinic anhydride and β-bromopropionic anhydride; these may be used by mixture of two kinds or more. From the viewpoint of costs and handleability, acetic anhydride, propionic anhydride, butyric anhydride and isobutyric anhydride are preferable, and acetic anhydride is more preferable.

In the transesterification, an acyl group of the acylated product is preferably by 0.8 to 1.2 times equivalent to a carboxyl group.

The transesterification is performed preferably at a temperature of 130 to 400° C. while heating up at a rate of 0.1 to 50° C./minute, more preferably at a temperature of 150 to 350° C. while heating up at a rate of 0.3 to 5° C./minute.

When the acylation reaction and the transesterification are conducted, by-produced fatty acid and unreacted fatty acid anhydride are preferably distilled out of the system by vaporizing to shift the equilibrium.

The acylation reaction and the transesterification may be performed in the presence of a catalyst. A catalyst conventionally known as a catalyst for polymerizing polyester may be used as the catalyst; examples thereof include metallic salt catalysts such as magnesium acetate, tin acetate, tetrabutyl titanate, lead acetate, sodium acetate, potassium acetate and antimony trioxide, and organic compound catalysts such as N,N-dimethylaminopyridine and N-methylimidazole.

Please note that, occasionally these catalysts are not removed from the produced liquid crystalline polymer but still remains in the liquid crystalline polymer. In such a case, the metal remaining in the liquid crystalline polymer may have a bad influence on electrical characteristics in a resin layer of FPC. Accordingly, organic compound catalysts are preferably used as the catalyst. Specifically, a heterocyclic compound containing a nitrogen atom such as N,N-dimethylaminopyridine and N-methylimidazole is preferably used (see, Japanese Unexamined Patent Publication No. 2002-146003).

The catalyst may exist for a period during the acylation reaction and the transesterification, and may be charged simultaneously with monomers for producing the liquid crystalline polymer before the acylation reaction, or charged during the acylation reaction or the transesterification.

Polycondensation by the transesterification may be performed by melt polymerization, and melt polymerization and solid-phase polymerization may be conducted together. The solid-phase polymerization may be performed in such a manner that the polymer is extracted from the process of melt polymerization, thereafter pulverized into powder or flakes, and thereafter heat-treated. Specific examples thereof include a method for heat-treating under an inert atmosphere such as nitrogen at a temperature of 20 to 350° C. for 1 to 30 hours in a solid-phase state. The solid-phase polymerization may be performed while stirred or in a state of still standing without being stirred. A melt polymerization tank and a solid-phase polymerization tank may be also made into the same reaction vessel by mounting a proper stirring mechanism. After the solid-phase polymerization, the obtained liquid crystalline polymer may be pelletized to provide good workability.

The production of the liquid crystalline polymer may be performed by using batch equipment and continuous equipment.

The weight-average molecular weight of the liquid crystalline polymer is not particularly limited, and may be in the range of from about 100,000 to about 500,000. Higher molecular weight of the liquid crystalline polymer tends to provide the resulting resin layer containing such a liquid crystalline polymer with a more favorable dimensional stability. As described above, when the liquid crystalline polymer is produced, melt polymerization and solid-phase polymerization together can contribute to obtain a higher molecular weight of the liquid crystalline polymer. Please note that, since the the weight-average molecular weight of the liquid crystalline polymer may affect solubility of the polymer in a solvent, the weight-average molecular weight of the liquid crystalline polymer is appropriately determined to easily provide a preferable solution comprising a liquid crystalline polymer and a solvent, as described later.

### <Resin Layer>

In the present invention, a resin layer comprising a liquid crystalline polymer described above is provided on at least one copper foil.

The resin layer may contain known fillers and additives as long as it does not adversely affect the present invention. Please note that when the resin layer contains the fillers and/or additives having a nickel component and/or a silicon component, these components may occasionally move from the resin layer to the copper foil, whose properties are deteriorated thereby. From such a viewpoint, fillers made from inorganic materials (namely, inorganic fillers) are preferably used in the resin layer, when fillers are added. The inorganic fillers has so high chemical stability that a nickel component and a silicon component are difficult to extricate and may be sufficiently prevented from moving to the copper foil.

Examples of the inorganic fillers include fibrous, particulate, tabular or whiskery inorganic fillers composed of materials such as silica, glass, alumina, titanium oxide, zirconia, kaolin, calcium carbonate, calcium phosphate, aluminum borate, magnesium sulfate, zinc oxide, silicon carbide and silicon nitride. Among these, particulate inorganic fillers or fibrous fillers such as glass fiber and alumina fiber composed of aluminum borate, potassium titanate, magnesium sulfate, zinc oxide, silicon carbide, silicon nitride or alumina are preferable. When the particulate inorganic fillers are used, the preferable fillers are such that, in particle-size cumulative distribution measured at a transmittance of approximately 80% by using laser diffraction particle-size distribution measuring equipment, i) particle diameter D10 (μ) corresponding to relative particle amount by 10% from the minimum particle diameter is in the range of from 1μ or smaller and ii) particle diameter D90 (μ) corresponding to relative particle amount by 90% is in the range of from 5μ or larger. Such particulate inorganic fillers are preferred in view of dimensional stability.

Such organic fillers that a nickel component and a silicon component are not extricated may be used in the resin layer in the present invention. Examples of such organic fillers may include epoxy resin powder, melamine resin powder, urea resin powder, benzoguanamine resin powder and styrene resin powder.

Examples of additives include a titanium coupling agent, an anti-settling agent, an ultraviolet absorbing agent and a heat stabilizer.

One or more kinds of these fillers and additives may be used.

In the resin layer, a resin component other than the liquid crystalline polymer may be contained as long as it does not adversely affect the present invention. Examples of the resin component other than the liquid crystalline polymer include thermoplastic resins such as polypropylene, polyamide, polyester, polyphenylene sulfide, polyether ketone, polycarbonate, polyether sulfone, polyphenyl ether and denatured products thereof and polyether imide, and elastomers such as a copolymer of glycidyl methacrylate and polyethylene. One or more kinds of such a resin component may be used if it does not deteriorate the effects of the present invention.

The resin layer is preferably prepared on the at least one copper foil by applying a liquid crystalline polymer solution comprising a liquid crystalline polymer and a solvent onto the copper foil, followed by removing the solvent. Such a cast method using the liquid crystalline polymer solution is advantageous in the present invention to form the resin layer from the viewpoint of developing excellent adhesion properties between the resin layer and the copper foil in the resulting laminate.

The cast method is described in detail below.

In the cast method, a liquid crystalline polymer solution obtained by dissolving a liquid crystalline polymer in solvent is applied to a copper foil or is cast on a copper foil, and then the solvent is removed by, for example heat-treating.

Examples of the solvent used for the liquid crystalline polymer solution include nonprotic solvents such as N,N-dimethylacetamide, N-methyl-pyrrolidone, N-methyl caprolactam, N,N-dimethylformamide, N,N-diethylformamide, N,N-diethylacetamide, N-methylpropionamido, dimethyl sulfoxide, γ-butyl lactone, dimethyl imidazolidinone, tetramethylphosphoricamide and ethyl Cellosolve acetate, and organic solvents such as halogenated phenols, for example, para-chlorophenol; above all, nonprotic solvents are preferable. One or more kinds of the solvents may be used alone or in the mixture thereof.

The liquid crystalline polymer solution may contain the liquid crystalline polymer in the concentration of form 0.5 to 50% by weight, preferably 5 to 30% by weight, with respect to the solvent.

When the concentration of liquid crystalline polymer is lower than the above range, productivity of the resin layer may decrease. On the other hand, when the concentration of liquid crystalline polymer is higher than the above range, the liquid crystalline polymer tends to be difficult to be dissolved in the solvent.

The liquid crystalline polymer solution is preferably filtered by a filter to remove fine foreign matters contained in the solution.

As described above, a resin layer containing inorganic fillers can be obtained using the liquid crystalline polymer solution containing the inorganic fillers.

The resin layer containing inorganic fillers can be provided using such a solution that the concentration of the inorganic fillers is in the range of from 100 parts by weight or less, preferably in the range of from 40 parts by weight or less, with respect to 100 parts by weight of the liquid crystalline polymer.

The inorganic fillers may be surface-treated to improve compatibility and adhesion properties to the liquid crystalline polymer. Please note that an agent used for surface treatment is appropriately selected so that nickel and silicon do not move easily from the resin layer to the copper foil.

In a method for producing a copper-clad laminate of the present invention, such a liquid crystalline polymer solution is coated on the copper foil, and then the solvent is removed from the coated film. A method for removing the solvent is not particularly limited, and the solvent may be removed preferably by vaporizing the solvent. Heat treatment, decompression treatment, ventilation treatment or a combination thereof may be performed as a method for vaporizing the solvent. Above all, heat treatment is more preferable, and the temperature conditions in the heat treatment are preferably in the range of from about 80 to about 200° C. The time for the heat treatment is in the range of from about 10 to about 20 minutes.

With regard to a copper-clad laminate of the present invention, the resin layer may be also reformed by removing the solvent by heat treatment to thereafter further perform heat treatment. This reforming is performed for controlling the orientation of the liquid crystalline polymer in the resin layer, and such reforming may improve the properties such as mechanical strength of the resin layer. The conditions of heat treatment according to the reforming are preferably 250° C. or more and 350° C. or less, and the time is preferably 600 minutes or less. The heat treatment according to the reforming is preferably performed under an inert gas atmosphere such as nitrogen.

### <Copper-Clad Laminate>

When one copper foil is used in the present invention, a one-sided copper-clad laminate in which a copper foil attaches to one surface of a resin layer containing a liquid crystalline polymer can be obtained. Also, in the present invention, a double-sided copper-clad laminate can be obtained by further placing the second copper foil on the resin layer not adhering to the first copper foil in the one-sided copper-clad laminate obtained above. When the double-sided copper-clad laminate is produced, the second copper foil newly adhere to the copper foil is also preferably such a copper foil that the concentration ratio C_{Ni}/C_{Cu} of nickel to copper obtained by the above-mentioned XPS measurement is 0.40 or more and silicon is not substantially detected. In order to further allow the copper foil to adhere to the resin layer of the copper-clad laminate, the resin layer and the copper foil may be more strongly attached to each other by thermo-compression bonding under an inert atmosphere. The heating temperature according to thermo-compression bonding is in the range of from 150 to 370° C., preferably in the range of from 250 to 350° C. Examples of the method for compression bonding include hot pressing method, continuous roll laminate method and continuous belting press method.

When a double-sided copper-clad laminate is produced, the above-described heat treatment may be subjected to the resin layer before placing the second copper foil. Namely, the double-sided copper-clad laminate may be produced by a method in which the first copper foil is placed onto the resin layer containing the liquid crystalline polymer so that the resin layer adheres to a surface of the copper foil, the resin layer is subject to a heat treatment, and then the second copper foil is placed onto a surface of the resin layer, the surface not previously adhering to the first copper foil. After the placement of the second layer, the resulting laminate may be further subjected to the heat treatment.

The one-sided copper-clad laminate and double-sided copper-clad laminate of the present invention thus obtained are not merely excellent in adhesion properties between the copper foil and the resin layer immediately after being produced, but also has the properties such that adhesion properties between the copper foil and the resin layer are scarcely decreased even though these laminates are retained under high temperature and humidity atmosphere. Such copper-clad laminates are extremely appropriate for obtaining FPC excellent in practicability, and the use thereof is not limited to FPC and the laminates may be appropriately used also for a semiconductor package, a multilayer printed-circuit board for a motherboard and a tape-automated bonding film, which are obtained by a built-up method noted in recent years.

The invention being thus described, it will be apparent that the same may be varied in many ways. Such variations are to be regarded as within the spirit and scope of the invention, and all such modifications as would be apparent to one skilled in the art are intended to be within the scope of the following claims.

### EXAMPLES

The present invention is described in more detail by following Examples, which should not be construed as a limitation upon the scope of the present invention. The treating method and evaluation method of a copper-clad laminate in Examples and Comparative examples adopted the following methods.

### XPS Measurement:

The wide scan spectrum was measured by using SSX-100 manufactured by SSI (Surface Science Instruments) to perform surface composition ratio analysis.
Technique: X-ray photoelectron spectroscopy
X-rays: AlKα ray (1486.6 eV)
X-ray spot diameter: 1000 μm
Neutralization conditions: neutralization electron gun with Ni mesh used
Unit: % by atom

With regard to the energy axis of the measured spectrum, the spot of the main peak of C1s was calibrated as 284.6 eV. The narrow scan spectrum was particularly measured for the spectrum of Si2p and Ni2p_{3/2} to determine the presence or absence of the 852-eV peak of Si2p and Ni2p_{3/2}.

The results of measuring an electrolytic copper foil 1, an electrolytic copper foil 2, an electrolytic copper foil 3, an electrolytic copper foil 4, an electrolytic copper foil 5, an electrolytic copper foil 6, an electrolytic copper foil 7 and an electrolytic copper foil 8 (occasionally described as “electrolytic copper foil 1 to 8” hereinafter) used in the following examples and comparative examples are shown in Table 1.

### Storage Under High Temperature and Humidity Atmosphere:

The produced copper-clad laminate was stored for 168 hours in a furnace allowing an atmosphere of 121° C., 2 atm and 100% RH to perform the treatment.

### Adhesion Properties Measurement:

90°-peel strength was measured as adhesion properties measurement.

The copper-clad laminate was cut out into a test piece with a width of 10 mm, and the resin surface was fixed to measure 90°-peel strength at a peel rate of 50 mm/minute with the copper foil, whereby peel strength between the resin layer and the copper foil of the copper-clad laminate was measured.

### Production Example 1

941 g (5.0 mol) of 2-hydroxy-6-naphthoic acid, 273 g (2.5 mol) of 4-aminophenol, 415.3 g (2.5 mol) of isophthalic acid and 1123 g (11 mol) of acetic anhydride were charged into a reaction vessel provided with a stirring apparatus, a torque meter, a nitrogen inlet tube, a thermometer and a reflux condenser. The inside of the reaction vessel was sufficiently substituted with nitrogen gas, thereafter heated up to a temperature of 150° C. under a nitrogen gas current over 15 minutes, and then refluxed for 3 hours while retaining the temperature.

Thereafter, the reaction vessel was heated up to a temperature of 320° C. over 170 minutes while distilling off by-produced acetic acid distilled out and unreacted acetic anhydride, and the point of time when a rise in torque was observed was regarded as the end of the reaction to take out the contents. The obtained resin was pulverized by a coarse crusher, and thereafter a part of liquid crystal polyester powder was heated up at a rate of 10° C./minute and observed by a polarizing microscope to consequently show a schlieren pattern characteristic of a liquid crystal phase at a temperature of 350° C.

### Example 1

The liquid crystalline polymer powder after being coarsely pulverized, which was obtained in Production Example 1, was retained under a nitrogen atmosphere at a temperature of 250° C. for 3 hours to advance polymerization reaction in a solid phase. Subsequently, 8 g of the obtained liquid crystalline polymer powder was added to 92 g of N-methyl-2-pyrrolidone, heated to a temperature of 160° C. and completely dissolved to obtain a transparent solution in brown. This solution was stirred and defoamed to obtain a liquid crystalline polymer solution.

Aluminum borate (ALBOREX M20C: manufactured by Shikoku Chemicals Corp., D10=0.18μ, D90=5.65μ, specific gravity of 3.0 g/cm³) as an inorganic filler was added to the liquid crystalline polymer solution obtained herein so as to become 19.6% by weight with respect to the liquid crystalline polymer, dispersed and defoamed, thereafter cast on an electrolytic copper foil 1 (a thickness of 12 μm) with a surface roughness of 2.1 μm by using a film applicator, and then dried on a hot plate at a temperature of 80° C. for 1 hour. The solution was heated to a temperature of 320° C. starting with 30° C. under a nitrogen atmosphere in a hot-air oven at a rate of temperature rise of 0.5° C./minute to perform heat treatment for retaining the temperature for 3 hours and stand still to room temperature under a nitrogen atmosphere, whereby a copper-clad laminate was produced. The thickness of the resin layer was 25 μm. The results of evaluating the obtained copper-clad laminate are shown in Table 1.

### Example 2

The test was performed in the same manner as Example 1 except for using an electrolytic copper foil 2 (a thickness of 12 μm) with a surface roughness of 2.1 μm as the copper foil. The results are shown in Table 1.

### Comparative Examples 1 to 6

The test was performed in the same manner as Example 1 except for using electrolytic copper foil 3 to 8 (all of them have a thickness of 12 μm) with a surface roughness of 2.1 μm as the copper foil. The results are shown in Table 1.

TABLE 1

| | | | | Comparative | Comparative | Comparative | Comparative | Comparative | Comparative |
|---|---|---|---|---|---|---|---|---|---|
| | | Example 1 | Example 2 | Example 1 | Example 2 | Example 3 | Example 4 | Example 5 | Example 6 |
| | | electrolytic | electrolytic | electrolytic | electrolytic | electrolytic | electrolytic | electrolytic | electrolytic |
| | | copper foil 1 | copper foil 2 | copper foil 3 | copper foil 4 | copper foil 5 | copper foil 6 | copper foil 7 | copper foil 8 |
| XPS | Ni2p_{3/2} | 5 | 7 | 2 | 0 | 0 | 0 | 4 | 4 |
| analysis | Cu2p_{3/2} | 11 | 11 | 6 | 14 | 14 | 6 | 6 | 5 |
| (atom %) | Si2p | 0 | 0 | 0 | 0 | 0 | 3 | 3 | 6 |
| | (C_{Ni}/C_{Cu}) | 0.45 | 0.64 | 0.33 | 0 | 0 | 0 | 0.67 | 0.80 |
| | Ni852 eV (*2) | X | X | ◯ | X | X | X | ◯ | ◯ |
| peel | immediately | 8.2 | 8.1 | 8.4 | 8.9 | 9.4 | 9.1 | 8.7 | 8.5 |
| strength | after being | | | | | | | | |
| (N/cm) | produced | | | | | | | | |
| | after being | 6.8 | 6.7 | 2.9 | 0.3 | 0.8 | 0.3 | 4.3 | 4.4 |
| | stored for 168 | | | | | | | | |
| | hours | | | | | | | | |
| | retention rate (%) (*2) | 83 | 83 | 35 | 3 | 9 | 3 | 49 | 52 |

*1 The case where the peak derived from Ni2p with a binding energy of 852 eV was detected and the case where not detected was denoted as ‘◯’ and ‘X’, respectively.
(*2) The retention rate was calculated by the following expression. [Retention rate (%)] = {[peel strength 168 hours after]/[peel strength immediately after being produced]} × 100

As found from the results of Table 1, it has proven that the copper-clad laminate of Examples 1 and 2 using copper foil such that C_{Ni}/C_{Cu} is 0.40 or more and silicon is not detected may maintain high adhesion properties even before and after being stored under high temperature and humidity atmosphere, but the copper-clad laminate of Comparative Examples 1 to 6 causes adhesion properties to greatly decrease.

### Example 3

On the copper-clad laminate that was obtained in Example 1A, another electrolytic copper foil 1 (second copper foil; a thickness of 12 μm) is placed. At that time, the second copper foil is placed onto a surface of the resin layer of the laminate, the surface not previously adhering to the first copper foil. Namely, the second copper foil is placed on a resin-layer surface opposite to the resin-layer surface on which the first copper foil has been present. Then, while heating, the resulting laminate is pressed in the direction of accumulation of layers in which the first electrolytic copper foil, the resin layer and the second electrolytic copper foil are accumulated in this order, thereby producing a double-sided copper-clad laminate in which the first electrolytic copper foil, the resin layer and the second electrolytic copper foil are accumulated and are adhered to one another in this order. The heating and pressing can be conducted using a pressing machine (for example, model VH1-1765 manufactured by Kitagawa Seiki Co., Ltd.) with pressing under press pressure of 5 MPa under such heating conditions that the temperature is raised to about 340° C. in vacuum over 60 minutes and then is maintained at about 340° C. for 20 minutes.

What is claimed is:

1. A method for producing a copper-clad laminate, the method comprising the step of placing at least one copper foil onto a resin layer containing a liquid crystalline polymer so that the resin layer adheres to a surface of the copper foil, wherein the surface of the copper foil has 0.4 or more of a ratio of nickel concentration to copper concentration and has substantially no silicon detected when measured with X-ray photoelectron spectroscopy.

2. The method according to claim 1, wherein the surface of the copper foil is a surface in which a peak derived from Ni2p with a binding energy of 852 eV is not detected in the measurement of X-ray photoelectron spectroscopy.

3. The method according to claim 1, wherein the resin layer is prepared on the copper foil by applying a liquid crystalline polymer solution comprising the liquid crystalline polymer and a solvent onto the copper foil, followed by removing the solvent.

4. The method according to claim 1, wherein the liquid crystalline polymer has the structural units represented by the following formulae (1), (2) and (3):
—O—Ar¹—CO— (1)
—CO—Ar²—CO— (2)
—X—Ar³—Y— (3)
wherein Ar¹ denotes phenylene, naphthylene or biphenylene; Ar² denotes phenylene, naphthylene, biphenylene or a divalent group represented by the formula (4); Ar³ denotes phenylene or a divalent group represented by the formula (4) below; X and Y identically or differently denote O or NH, respectively; and a hydrogen atom bonding to an aromatic ring of Ar¹, Ar² and Ar³ may be substituted with a halogen atom, an alkyl group or an aryl group; and
—Ar¹⁰-Z-Ar¹¹— (4)
wherein Ar¹⁰ and Ar¹¹ each independently denote phenylene or naphthylene; and Z denotes O, CO or SO₂; and wherein the liquid crystalline polymer has the structural unit (1) in the amount of from 30 to 80% by mol, the structural unit (2) in the amount of from 10 to 35% by mol, and the structural unit (3) in the amount of from 10 to 35% by mol, with respect to the total amount of the structural units (1), (2) and (3).

5. The method according to claim 4, wherein at least one of X and Y in the structural unit (3) is NH.

6. The method according to claim 1, wherein the resin layer contains an inorganic filler.

7. The method according to claim 1, in which two copper foils are placed respectively on each of surfaces of the resin layer.

8. The method according to claim 1, further comprising the step of heating the resin layer.

9. The method according to claim 1, in which the first copper foil is placed onto the resin layer containing the liquid crystalline polymer so that the resin layer adheres to a surface of the copper foil, the resin layer is subject to a heat treatment, and then the second copper foil is placed onto a surface of the resin layer, the surface not previously adhering to the first copper foil.
